(19) United States
(12) Patent Application Publication
(10) Pub. No.: US 2015/0129118 A1
(43) Pub. Date: May 14, 2015

(54) Compression Molding of Composite Structures Using Flexible Tooling

(71) Applicant: The Boeing Company, Chicago, IL (US)

(72) Inventors: Gregory James Schoepen Hickman, University City, MO (US); Randall Dow Wilkerson, O'Fallon, MO (US)

(21) Appl. No.: 14/602,699

(22) Filed: Jan. 22, 2015

Related U.S. Application Data
(63) Continuation-in-part of application No. 13/934,884, filed on Jul. 3, 2013.
Application No. 13/934,884 is a division of application No. 11/701,789, filed on Feb. 3, 2007, now Pat. No. 8,491,745.
Application No. 11/701,789 is a continuation-in-part of application No. 14/182,215, filed on Feb. 17, 2014.
Application No. 14/182,215 is a division of application No. 12/398,071, filed on Mar. 4, 2009, now Pat. No. 8,691,137.
Application No. 12/398,071 is a continuation-in-part of application No. 13/419,187, filed on Mar. 13, 2012.
Application No. 13/419,187 is a continuation-in-part of application No. 12/868,896, filed on Aug. 26, 2010, now Pat. No. 8,795,457.
Application No. 12/868,896 is a continuation of application No. 11/347,122, filed on Feb. 2, 2006, now Pat. No. 7,807,005.
Application No. 13/419,187 is a continuation-in-part of application No. 12/398,071, filed on Mar. 4, 2009, now Pat. No. 8,691,137.
Application No. 12/398,071 is a continuation-in-part of application No. 11/697,378, filed on Apr. 6, 2007, now Pat. No. 8,425,708.
Application No. 11/697,378 is a continuation-in-part of application No. 11/347,122, filed on Feb. 2, 2006, now Pat. No. 7,807,005.
Application No. 13/419,187 is a continuation-in-part of application No. 11/699,653, filed on Jan. 29, 2007.
Application No. 11/699,653 is a continuation-in-part of application No. 11/584,923, filed on Oct. 20, 2006, now Pat. No. 8,333,858.
Application No. 11/584,923 is a continuation-in-part of application No. 11/347,122, filed on Feb. 2, 2006, now Pat. No. 7,807,005.
Application No. 11/699,653 is a continuation-in-part of application No. 11/347,122, filed on Feb. 2, 2006, now Pat. No. 7,807,005.
Application No. 13/419,187 is a continuation-in-part of application No. 11/584,923, filed on Oct. 20, 2006, now Pat. No. 8,333,858.
Application No. 11/584,923 is a continuation-in-part of application No. 11/347,122, filed on Feb. 2, 2006, now Pat. No. 7,807,005.
Application No. 13/419,187 is a continuation-in-part of application No. 11/347,122, filed on Feb. 2, 2006, now Pat. No. 7,807,005.

(51) Int. Cl. B32B 37/10; B32B 37/00; B32B 38/00

(52) U.S. Cl. CPC B32B 37/1027; B32B 38/0012; B32B 37/0046
USPC 156/199; 156/443; 156/221

(57) ABSTRACT

A tool for compression molding a composite laminate charge has a tool face for compressing the charge. A flexible tool feature on the tool face forms a shape in the charge and compensates for tool surfaces that may be out-of-tolerance.

### CROSS REFERENCE TO RELATED APPLICATIONS

This application is a continuation-in-part of prior co-pending U.S. patent application Ser. Nos. 13/934,884 filed Jul. 3, 2013 and published as US Patent Publication No. 20140014274 A1; Ser. No. 14/182,215 filed Feb. 17, 2014 and published as US Patent Publication No. 20140314894 A1; and Ser. No. 13/419,187 filed Mar. 13, 2012, the entire disclosures of which are incorporated by reference herein.

### BACKGROUND INFORMATION

1. Field

The present disclosure generally relates to methods and equipment for fabricating composite structures, and deals more particularly with compression molding using flexible tooling to achieve even pressure distribution over the structure.

2. Background

Matched metal tools may be used in compression molding to compress composite laminates into a desired part geometry. The tools may be shaped to apply pressure on the laminate with a changing thickness or shape corresponding to the shape of the part. In order to assure that even tool pressure is applied over the entire surface of the laminate, the tools must be fabricated with high precision and close tolerances. Slight variations in tool geometry from nominal dimensions may result in an undesired hard stop between matching tools when they are closed against the laminate during the molding process. A hard stop between tools in one area of the laminate may relieve the pressure applied in other areas, resulting in less-than-desired consolidation of the part.

Avoiding hard stops between metal tool surfaces is particularly challenging in certain types of compression molding such as continuous compression molding (CCM) used to produce composite laminate parts having stepped thicknesses along their length. In the CCM process, metal tool sleeves are continuously fed in a step-wise manner along with a composite laminate charge through a CCM machine where dies compress the tool sleeves against the laminate to form a consolidated part having features that substantially match those of the tool sleeves. The laminate charge and the tool sleeves are subjected to relatively rapid changes in temperature as they are preheated, then heated to the laminate forming temperature and finally cooled. These changes in temperature cause the tool sleeves to expand and contract, making it difficult to maintain the desired dimensional tolerances of the tool surfaces. Hard stops between the tools may occur when tool surfaces expanded beyond tolerance limits due to these temperature variations. As explained above, hard stops may cause an uneven pressure distribution that may have an undesirable effect on part consolidation.

Accordingly, there is a need for tools for producing composite laminate parts having complex dimensions and/or thickness changes which allow an even distribution of pressure to be applied over the part. There is also a need for tool sleeves used in a CCM process that avoid the need for holding tight tolerances on tool surfaces, and which are simple to fabricate.

### SUMMARY

The disclosed embodiments provide compression molding tools for forming and consolidating composite laminate parts having complex geometries and/or thickness changes over the width and/or length of the part. The tools include flexible tool features that flex to allow substantially even compaction pressure to be applied over the part during the molding process. The tools may be formed as tool sleeves employed in continuous compression molding of composite laminate parts. The flexible tool features are easy and cost effective to fabricate, and may reduce the need for precision machining of metal tools to hold tight tolerances. The flexible tool features may also be easily reconfigured to suit differing part geometries, thereby reducing tool costs.

According to one disclosed embodiment, a tool is provided for molding a composite laminate charge. The tool includes a tool face, and a flexible tool feature the on the tool face for forming a shape in the composite laminate charge. The tool face may be a metal, and the flexible tool feature may be a polymer having a hardness that is less than the hardness of the metal tool face. In one variation, the flexible tool feature is a polyimide material. The tool may further comprise a polymeric foil, and the flexible tool feature may be formed on the polymeric foil. In another variation, the tool may include a metal foil, and the flexible tool feature may be formed on the metal foil. In still other variations, the flexible tool feature may be a laminate and may be bonded to the tool face.

According to another disclosed embodiment, a molding tool is provided, comprising a flexible tool sleeve configured to mold a composite laminate charge into a shaped part, and at least one polymeric tool feature on the tool sleeve configured to form a shape in the charge and maintain a substantially even pressure distribution throughout the part. In one variation, the flexible tool sleeve is a metal and includes at least one tool face, and the polymeric tool feature is bonded to the tool face. The polymeric tool feature may be a polyimide. The flexible tool sleeve and the flexible tool feature may be integrally formed. In another variation, the flexible tool feature may be a flexible polyimide laminate. In a further variation, the flexible tool sleeve may be a polymeric foil, and polymeric tool feature may be a polyimide.

According to a further disclose embodiment, a method is provided of forming a composite part. A flexible tool feature is positioned on a face of a tool, and the tool face is brought into contact with a composite charge. The flexible tool feature may be positioned on the face of the tool by bonding. The composite charge is compressed with the tool, and the flexible tool features are used to shape the composite charge, while flexing as necessary to assure that the tool applies even pressure over the entire area of the composite charge. The flexible tool feature may be bonded to the face of the tool. The method may further comprise machining the flexible tool feature to a desired shape. In one application, bringing the face of the tool into contact with the composite charge is performed by feeding the tool and the composite charge into a continuous compression molding machine.

According to still another disclosed embodiment, a method is provided of compression molding a composite part. The method includes fabricating a flexible tool sleeve, and positioning at least one flexible tool feature on the tool sleeve. The method also includes feeding a composite charge and the flexible tool sleeve substantially continuously through a molding machine, and compression molding the composite charge. The flexible tool feature is used to shape a feature of the part.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and advantages thereof, will best be understood by reference to the following detailed description of an illustrative embodiment of the present disclosure when read in conjunction with the accompanying drawings, wherein:

FIG. 1 is an illustration of a perspective view of a composite laminate I-beam.

FIG. 2 is an illustration of an exploded cross-sectional view of components of the I-beam shown in FIG. 1.

FIG. 3 is an illustration of a perspective view of a compression molded composite laminate C-channel.

FIG. 4 is an illustration of a cross-sectional view taken along the line 4-4 in FIG. 3.

FIG. 5 is an illustration of an edge of the C-channel FIG. 3, viewed in the direction designated as “FIG. 5” in FIG. 3.

FIG. 6 is an illustration of a perspective view of a tool sleeve having flexible tool features used to compression mold the C-channel shown in FIG. 3.

FIG. 7 is an illustration of a sectional view taken along the line 7-7 in FIG. 6.

FIG. 8 is an illustration of the area designated as “FIG. 8” in FIG. 7

FIG. 9 is an illustration of a cross-sectional view of a tool sleeve foil having a bonded flexible tool feature.

FIG. 10 is an illustration of a cross-sectional view of a tool sleeve foil having an integrally formed flexible tool feature.

FIG. 11 is an illustration of a cross-sectional view of a laminated tool sleeve foil having a laminated flexible tool feature.

FIG. 12 is an illustration of a diagrammatic view of a continuous compression molding machine.

FIG. 13 is an illustration of slightly exploded, cross-sectional view of set of matched tools used in the continuous compression molding machine shown in FIG. 12.

FIG. 14 is an illustration of a diagrammatic, cross-sectional view of a compression molding machine having a set of matched tools with a flexible tool feature.

FIG. 15 is an illustration of a flow diagram of a method of compression molding a composite laminate part using tools having flexible tool features.

FIG. 16 is an illustration of a flow diagram of a method of continuous compression molding using tool sleeves having flexible tool features.

FIG. 17 is an illustration of a flow diagram of aircraft production and service methodology.

FIG. 18 is an illustration of a block diagram of an aircraft.

### DETAILED DESCRIPTION

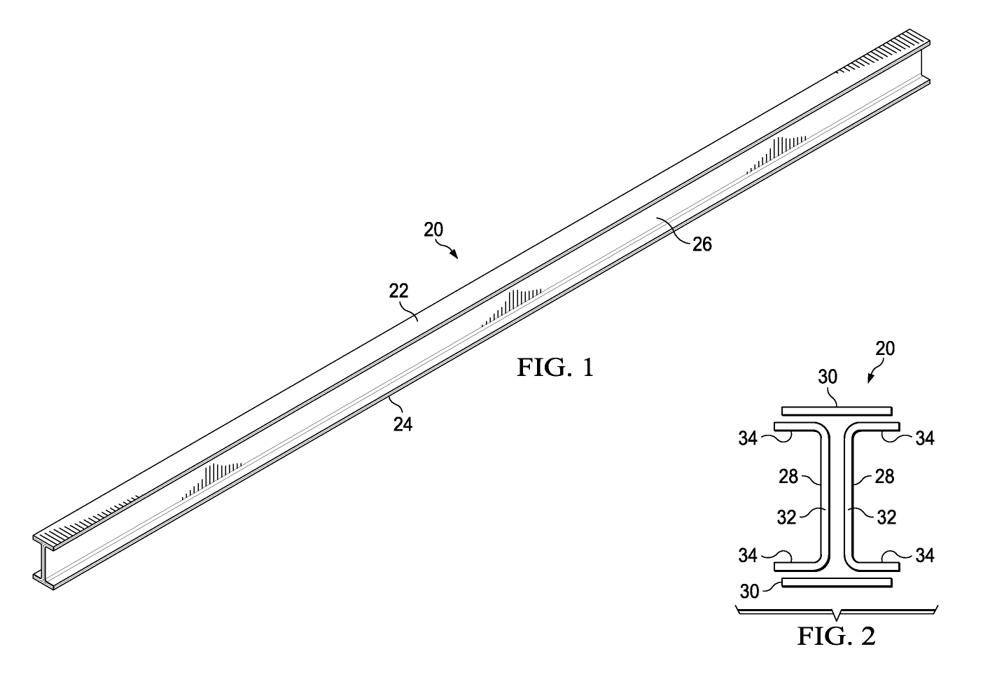

The disclosed embodiments relate to flexible tooling and a method of compression molding composite parts such as, without limitation shaped laminates, especially thermoplastics. As will be discussed later in more detail, the disclosed embodiments reduce or prevent hard stops from occurring between matching or mating tools that are used to compression mold composite parts. As used herein, a “hard stop” refers to a condition in which the distance between local areas of the matching tools, when closed, is less than a specified nominal value. When this distance between the matching tools is less than the nominal value, a greater than desired amount of pressure is locally applied to the part, causing less-than-desired compaction pressure to be applied to other areas of the part. Referring now to FIGS. 1 and 2, a typical composite laminate part comprises a composite laminate beam 20 having an I-shaped cross-section, hereinafter referred to as an I-beam. As shown in FIG. 1, the I-beam 20 includes a pair of cap regions 22, 24 connected by a web region 26. The I-beam 20 may be fabricated by consolidating multiple composite laminate components. For example, as shown in FIG. 2, the I-beam 20 may be fabricated by consolidating a pair of C-channels 28 with a pair of flat caps 30. Each of the C-channels 28 includes a web 32 and a pair of outwardly turned flanges 34.

Although an I-beam 20 has been illustrated in the exemplary embodiment, it is to be understood that the flexible tooling and disclosed method may be employed to fabricate any of a variety of composite structures, including beams and stiffeners having other cross sectional shapes. Moreover, the flexible tooling and disclosed method may be employed to fabricate composite structures and parts that are either substantially straight or contain one or more contours or curvatures along their length. Additionally, while the disclosed flexible tooling and method are suited for fabricating structures formed of thermoplastic materials, it may be possible to employ the flexible tooling and method to fabricate structures formed of other materials such as, without limitation, ceramics, thermosets and hybrid materials comprising both thermoplastics and thermoset.

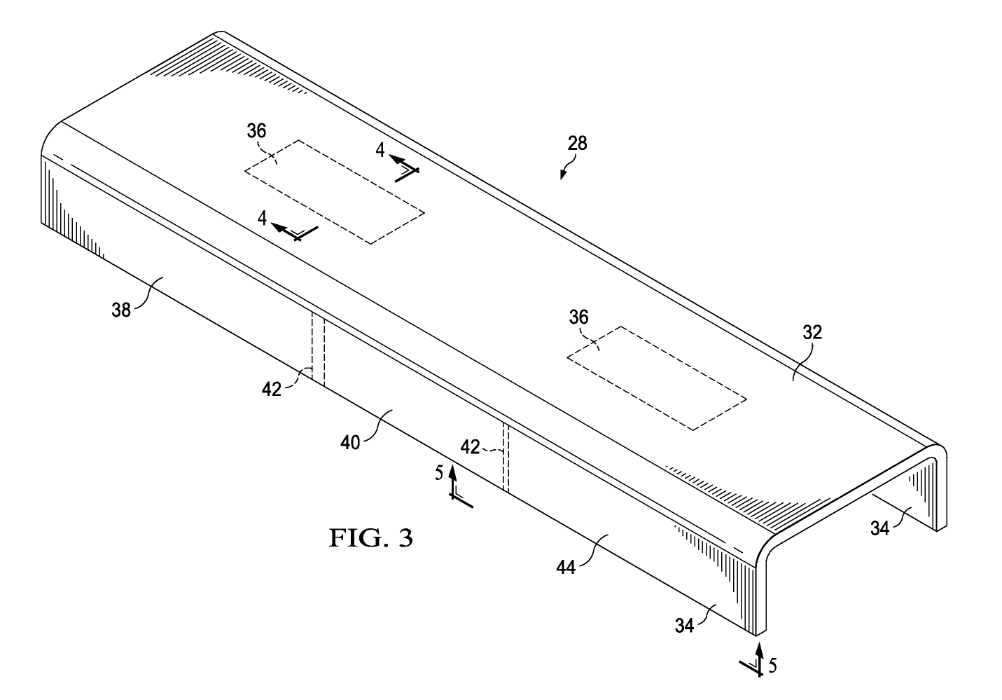

FIGS. 3, 4 and 5 illustrate one of the C-channels 28 shown in FIG. 2 which possesses a varying cross-sectional shape and varying thicknesses along its width and length. The C-channel 28 may comprise a composite laminate, such as, without limitation, a fiber reinforced thermoplastic suitable for the application. The web 32 includes a pair of recessed features 36, each having a depth “d” formed by longitudinally spaced areas of reduced laminate thickness. Similarly, each of the flanges 34 may have features formed by varying laminate thicknesses along the length of the flange 34. For example, the outer ends of the flanges 34 of the illustrated embodiment include sections 38, 44 (FIG. 3) of reduced thickness “t₁” (FIG. 5) formed by tapered ply drop-offs 42 which transition into sections 40 having a full laminate thickness “t₂”.

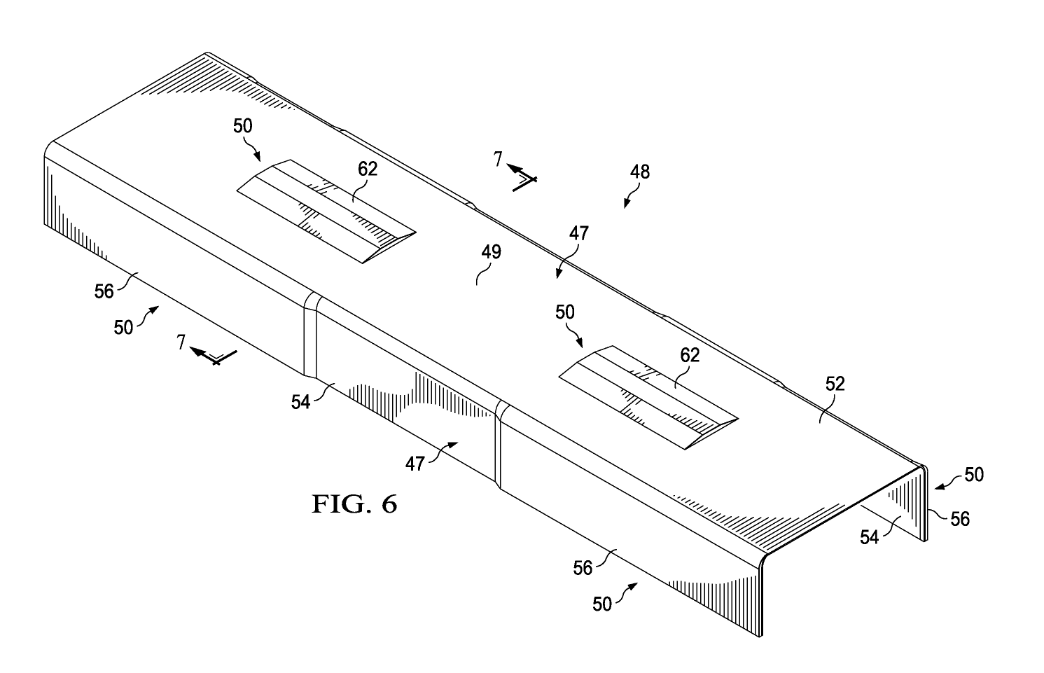

FIGS. 6, 7 and 8 illustrate a flexible tool sleeve 48 suitable for forming the C-channels 28 shown in FIGS. 3-5 in a continuous compression molding process described later in more detail. In one embodiment, the tool sleeve 48 comprises a relatively thin, flexible foil 49 comprising a pair of flanges 54 connected by a web 52. The foil 49 may comprise a steel alloy or other metal suitable for the application, however the foil 49 may be formed of other materials, as will be discussed below. In one practical embodiment used in continuous compression molding of thermoplastic laminates, the foil 49 may be a steel alloy having a thickness of between approximately 0.004 and approximately 0.012 inches. The tool sleeve 48 includes flexible tool features 50 that are attached to or are formed integral with one or more tool faces 47 on the foil 49.

The flexible tool features 50 have shapes and dimensions substantially matching the features of varying thickness to be formed in the C-channel 28. The flexible tool features 50 are sized and shaped to allow the tool sleeve 48 to apply and maintain a substantially even pressure distribution throughout the part during the molding process. In the illustrated example, the flexible tool features 50 include a first pair of flexible patches located on the web 52, and a second pair of flexible patches 56 located on each of the flanges 54. As used herein, the term “flexible” refers to the ability of the flexible tool features 50 to flex, compress or deform as needed, as the tool sleeve 48 applies pressure to a composite laminate during the compression molding process. The ability of the flexible patches 56, 62 to flex, compress or deform as needed, reduces or eliminates hard stops between tool features which may lead to uneven compaction pressure being applied to a composite charge be formed. The flexible tool features 50 (in this case the flexible patches 56, 62) compensate for matching tool surfaces that may be slightly out-of-tolerance, and which, when closed, apply higher than desired, local compaction pressures to the composite charge. It should be noted here that while the flexible tool features 50 are shown with discrete patches 56, 62, in some embodiments, the flexible tool features 50 may extend over substantially the entire length and/or width of the tool faces 47.

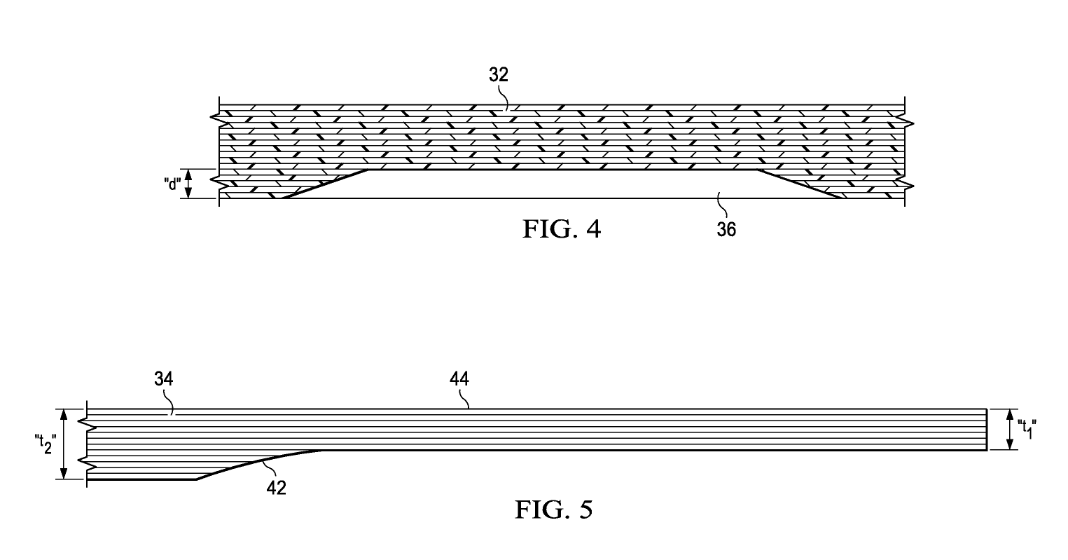

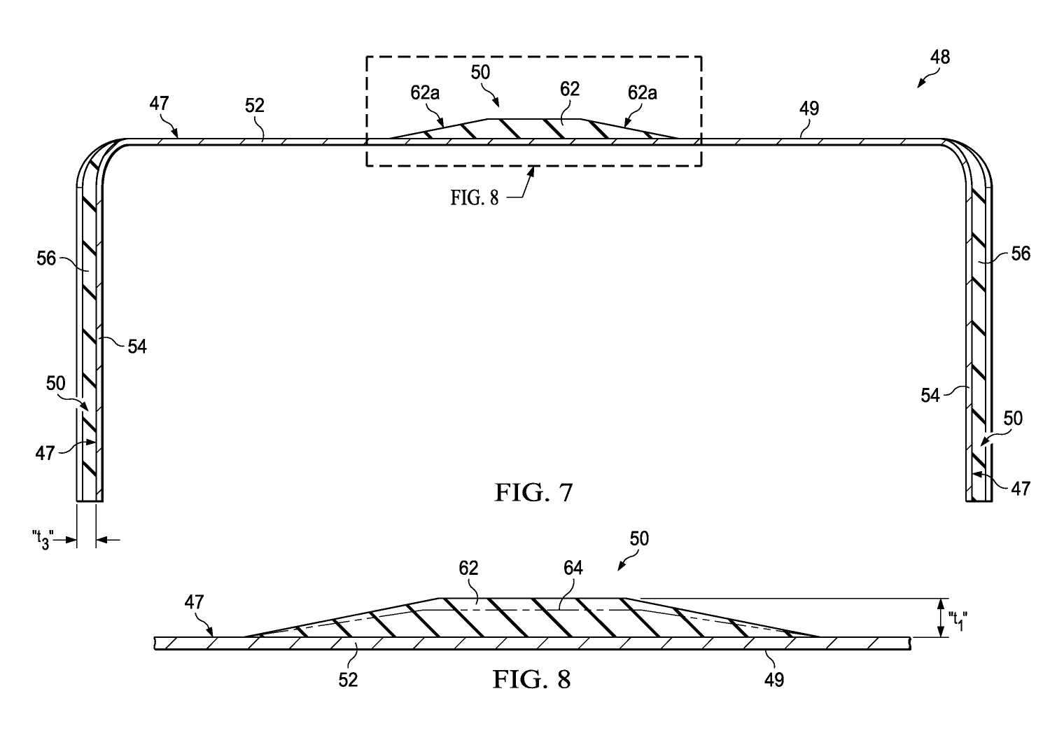

Referring particularly to FIGS. 7 and 8, the patches 62 on the web 52 of the tool sleeve 48 have a thickness “t₁” that is substantially equal to the depth “d” of the recessed features 36 (FIG. 4) that are formed by the patches 62 in the web 32 . Similarly, as shown in FIG. 7, the thickness “t₃” of the flange patches 56 is substantially equal to “t₂”−“t₁” (see FIG. 5). During a compression molding operation, the flexible tool features compress a composite laminate charge against a later discussed die or matching tool (both not shown). The flexible tool features 50 have a hardness and stiffness that is sufficient to apply the required compaction and forming pressure to the charge. However, depending upon the clearances between the tool sleeve 48 and matching die or tool, the patches 56, 62 may compress as indicated by the broken line 64 shown in FIG. 8, or otherwise flex and/or deform. Flexing of the patches 56, 62 prevents a hard stop between the tools/dies that may cause application of local higher-than-desired compaction forces, thereby the assuring substantially even compaction pressure is applied throughout the laminate charge. In some applications, the flexible tool features 50 may have dimensions that substantially match the nominal dimensions of the features to be molded. In other applications however, depending on the compressibility of the material from which the tooling features 50 are made, the flexible tool features 50 may have dimensions that are slightly greater than the nominal dimensions to assure that the tooling sleeve maintains even pressure throughout the part. When the laminate part has been formed and the compaction pressure is removed, the patches 56, 62 spring back to their original shapes, thus allowing the tool sleeve 48 to be reused to compression mold additional parts.

The flexible tool features 50 such as the patches 56, 62 described above may be formed of flexible materials that are suitable for the application. For example, without limitation, the flexible tool features 50 may be formed of a polyimide material having the required thickness achieved by laminating plies a polyimide film such as KAPTON®, or by molding a polyimide to the desired size and shape. The material from which the flexible tool features 50 are fabricated has a hardness that is suitable for the application and is able to withstand elevated temperatures typical of compression molding processes used to form thermoplastic laminates. For example, in continuous compression molding of thermoplastic laminates, the material from which the flexible tool features 50 should withstand temperatures of at least approximately 700° F. In one embodiment, the flexible tool features 50 may be fabricated by machining a polyimide to the desired size and shape, using any suitable technique including milling, cutting and/or drilling. Following machining, and surface preparation of the tool sleeve 48, the flexible tool features 50 may be attached to the tool faces 47 using a suitable bonding adhesive. In other embodiments, it may be possible to machine the flexible tool features 50 to the desired size and shape after they are bonded to the tool sleeve 48.

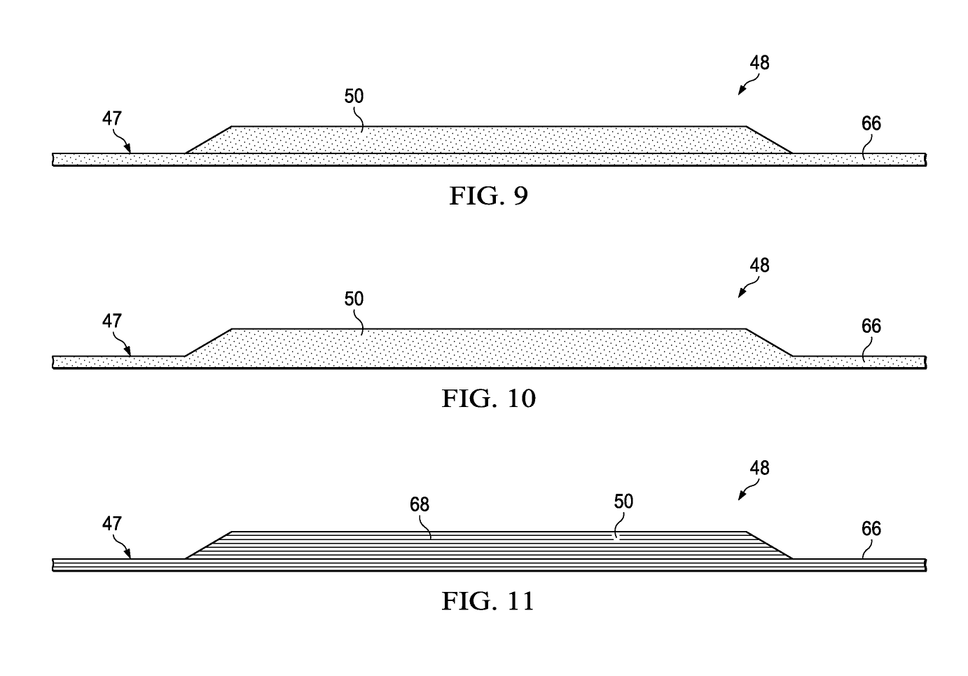

It may be possible to form the tool sleeve 48 from materials other than a metal. For example, referring to FIG. 9, the tool sleeve 48 may be formed of a polymeric foil 66 such as a polyimide, and the flexible tool features 58 may be bonded to the polymeric foil 60 using a suitable bonding adhesive. In another embodiment shown in FIG. 10, the flexible tool feature 50 may be integrally formed with the polymeric foil 66, either by machining or compression molding a polymeric material to the desired shape. In a further embodiment illustrated in FIG. 11, the tool sleeve 48 may comprise a foil 66 that is fabricated by laying up individual plies 68 of a flexible polymeric material such as polyimide which may or may not contain a reinforcement. The plies 68 are shaped to form the flexible features 50 by machining, molding or other suitable processes as described earlier.

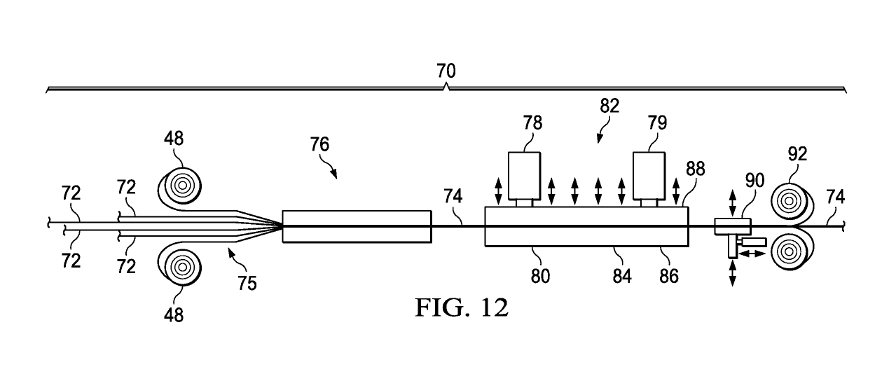

Fiber reinforced, thermoplastic laminate parts such as the I-beam 20 shown in FIG. 1 may be fabricated using the tool sleeves 48 described above, in a continuous compression molding (CCM) machine 70 shown in FIG. 12. The CCM machine 70 may be used to fabricate thermoplastic laminate parts 74 with cross-sectional features and/or thicknesses that vary along the length of the part 74. Moreover, the CCM machine 70 may be employed to fabricate parts that are either substantially straight or which have one or more contours, steps, joggles or other features along their lengths.

The CCM machine 70 broadly comprises a pre-forming zone 76 and a consolidation zone 82. In the pre-forming zone 76, a composite charge 75 comprising plies of fiber reinforced thermoplastic material are loaded in their proper orientations into ply stacks 72, and combined with tool sleeves 48 which have having flexible tool features 50 of the type previously described.

The stacks 72 of plies are fed, along with the tool sleeves 48, into the pre-forming zone 76 where they are preformed to the general shape of a part 74 at an elevated temperature. As previously discussed, each of the tool sleeves 48 may comprise a foil 66 (FIG. 9) having one or more flexible features 50 with sizes and shapes substantially matching varying features of the part 74. The pre-formed part 74 exits the pre-forming zone 76 and enters the consolidation zone 82, where it is consolidated to form a single, integrated thermoplastic laminate part 74. The elevated temperature used to pre-form the part 74 is sufficiently high to cause softening of the plies so that the plies in the stacks 72 may slip relative to each other, permitting the stacks 72 to be bent as needed during the pre-forming process. The pre-formed part 74 enters a separate or connected consolidating structure 79 within the consolidation zone 82.

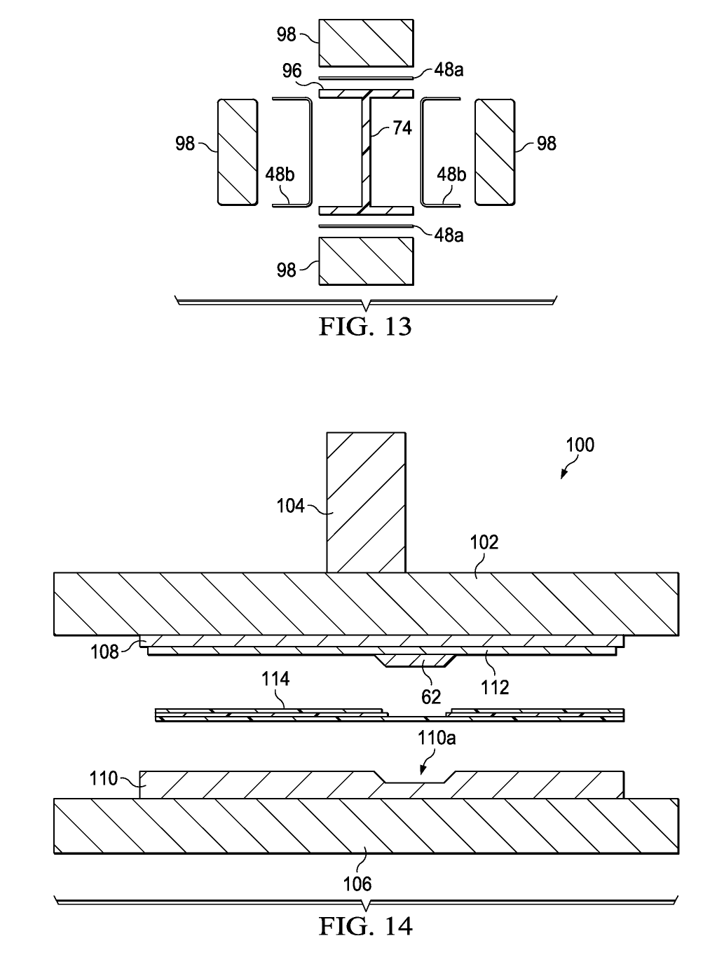

Referring now particularly to FIGS. 12 and 13, the consolidating structure 79 includes a plurality of standardized tool dies generally indicated at 88 that are individually mated with the tool sleeves 48. In the illustrated example, top and bottom tool sleeves 48a (FIG. 13) along with a pair of side tool sleeves 48b are used to consolidate both the cap regions 22, 24 (FIG. 1) and the web region 26 of an I-beam 20. One or more of the tool sleeves 48a, 48b may comprise a foil having one or more flexible tool features 50 of the type previously described. In other embodiments, depending upon the application, the flexible tool features 50 may be formed directly on the dies 98. The consolidating structure 79 has a pulsating structure 90 (FIG. 12) that incrementally moves the pre-formed part 74 forward within the consolidation zone 82 and away from the pre-forming zone 76. As the part 74 moves forward, the part 74 first enters a heating zone 80 that heats the pre-formed part 74 to a temperature which allows the free flow of the polymeric component of the matrix resin of the plies 72.

Next, the part 74 moves forward to a pressing zone 84, wherein standardized dies 88 are brought down collectively or individually at a predefined force (pressure) sufficient to consolidate (i.e. allow free flow of the matrix resin) the ply stacks 72 into the desired shape and thickness. Each die 88 in the pressing zone 84 is formed having a plurality of different temperature zones with insulators. The dies 88 are opened, and the part 74 is incrementally advanced within the consolidating structure 78 away from the pre-forming zone 76. The dies 88 are then closed again, allowing a portion of the pre-formed part 74 to be compressed under force within a different temperature zone. The process is repeated for each temperature zone as the pre-formed part 74 is incrementally advanced toward a cooling zone 86.

In the cooling zone 86, the temperature of the formed and shaped part 74 may be brought below the free flowing temperature of the matrix resin of the plies 72 thereby causing the fused or consolidated part 74 to harden to its ultimate pressed shape. The fully formed and consolidated part 74 then exits the consolidating structure 79, where the tool sleeves 48 may be collected at 92.

Referring now to FIG. 14, the tools having flexible tool features may be employed to mold a thermoplastic laminate charge 114 into a part using a conventional compression molding machine 100. Matched tools 108, 110 are respectively mounted on press platens 102, 106 that are forced together by a hydraulic ram 104. A metallic or polymeric foil 112 covers the face of the tool 108 and includes a flexible tool feature 62 having a size and shape that substantially matches a recess 110a in the tool 110. When the tools 108, 110 are forced together during a compression molding operation, the flexible tool feature 62 compresses the charge 114 into the recess 110a, and may flex slightly to avoid a hard stop between the tools 108, 110 which may have an undesirable effect on the pressure distribution across the charge 114. It should be noted here that it may be possible to employ the flexible tool features 50 previously described in tools used in other forming processes, such as without limitation, pultrusion and roll forming.

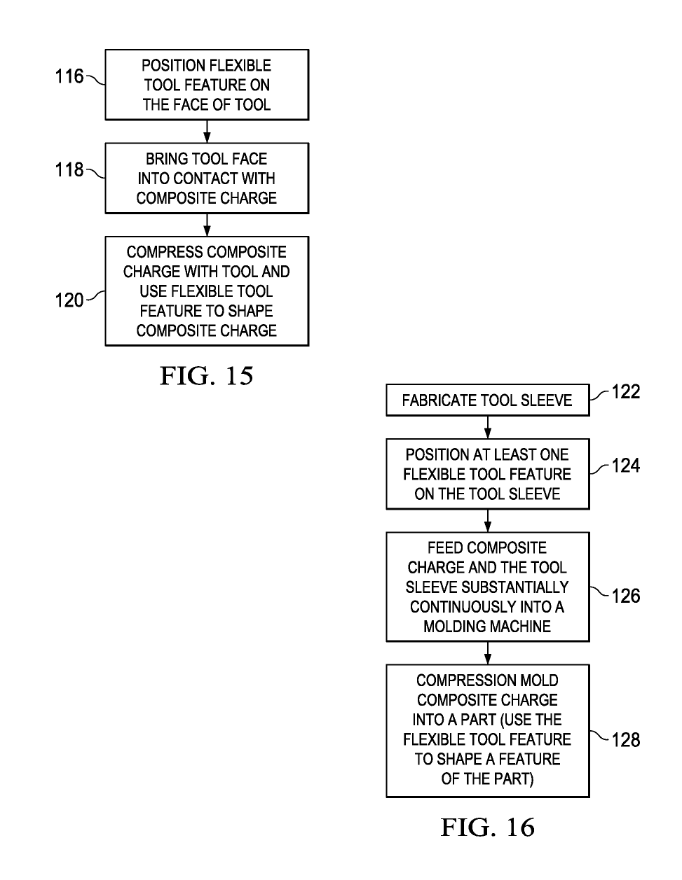

Attention is now directed to FIG. 15 which broadly illustrates the overall steps of a method of forming a composite part using tools 48 having one or more flexible tool features 50 on one or more faces 47 of the tools. At 116, one or more flexible tool features 50 are positioned on one or more faces 47 of a tool 48. As previously discussed, the flexible tool features 50 may be a flexible material such as a polyimide which is either bonded to, or integrally formed with the tool 48. At 118, the tool faces 47 are brought into contact with a composite laminate charge, which may comprise one or more stacks of a fiber reinforced thermoplastic. At 120, the composite charge is compressed by the tool, for example in a CCM machine 70 in which the tool is forced against the charge by a die. The flexible tool features 50 shape features of the composite part and compensate for tool surfaces that may be out of tolerance to assure that substantially even compaction pressure is applied over the entire area of the part.

FIG. 16 broadly illustrates the overall steps of a method of fabricating a composite part using the flexible tooling previously described. At 122, a suitable tool sleeve 48 is fabricated which, as previously discussed, may be formed of a metal or a polymeric material. At 124, at least one flexible tool feature 50 is positioned on the tool sleeve 48, for example using a bonding process. At 126, a composite charge, such as a stack 72 of reinforced thermoplastic plies, and the tool sleeve 48 are fed substantially continuously into a molding machine, such as a CCM machine 70. At 128, the composite charge is compression molded into a part, and the flexible tool feature 50 is used to shape a feature of the part.

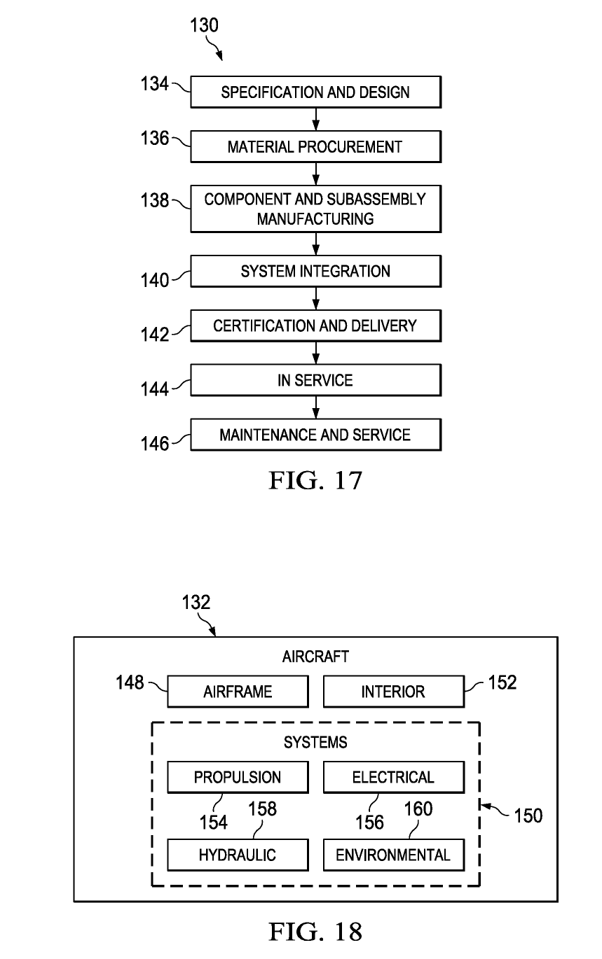

Embodiments of the disclosure may find use in a variety of potential applications, particularly in the transportation industry, including for example, aerospace, marine, automotive applications and other application where contoured elongate composite members, such as stiffeners, may be used. Thus, referring to FIGS. 17 and 18, embodiments of the disclosure may be used in the context of an aircraft manufacturing and service method 130 as shown in FIG. 17 and an aircraft 132 as shown in FIG. 18. Aircraft applications of the disclosed embodiments may include, for example, without limitation, beams, spars and other stiffeners. During pre-production, exemplary method 130 may include specification and design 134 of the aircraft 132 and material procurement 136. During production, component and subassembly manufacturing 138 and system integration 140 of the aircraft 132 takes place. Thereafter, the aircraft 132 may go through certification and delivery 142 in order to be placed in service 144. While in service by a customer, the aircraft 132 is scheduled for routine maintenance and service 146, which may also include modification, reconfiguration, refurbishment, and so on.

Each of the processes of method 130 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 18, the aircraft 132 produced by exemplary method 130 may include an airframe 148 with a plurality of systems 150 and an interior 152. The disclosed embodiments may be employed to fabricate beams, spars and other stiffeners forming part of the airframe 148. Examples of high-level systems 150 include one or more of a propulsion system 154, an electrical system 156, a hydraulic system 158 and an environmental system and 60. Any number of other systems may be included. Although an aerospace example is shown, the principles of the disclosure may be applied to other industries, such as the marine and automotive industries.

Systems and methods embodied herein may be employed during any one or more of the stages of the production and service method 130. For example, components or subassemblies corresponding to production process and 138 may be fabricated or manufactured in a manner similar to components or subassemblies produced while the aircraft 132 is in service. Also, one or more apparatus embodiments, method embodiments, or a combination thereof may be utilized during the production stages 138 and 140, for example, by substantially expediting assembly of or reducing the cost of an aircraft 132. Similarly, one or more of apparatus embodiments, method embodiments, or a combination thereof may be utilized while the aircraft 132 is in service, for example and without limitation, to maintenance and service 146.

As used herein, the phrase “at least one of”, when used with a list of items, means different combinations of one or more of the listed items may be used and only one of each item in the list may be needed. For example, “at least one of item A, item B, and item C” may include, without limitation, item A, item A and item B, or item B. This example also may include item A, item B, and item C or item B and item C. The item may be a particular object, thing, or a category. In other words, at least one of means any combination items and number of items may be used from the list but not all of the items in the list are required.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different advantages as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A tool for compression molding a composite laminate charge, comprising:
a tool face for compressing the composite laminate charge; and
a flexible tool feature on the tool face for forming a shape in the composite laminate charge.

2. The tool of claim 1, wherein:
the tool face is a metal having a hardness, and
the flexible tool feature is a polymer having a hardness less than the hardness of the metal.

3. The tool of claim 1, wherein the flexible tool feature is a polyimide material.

4. The tool of claim 1, further comprising:
a polymeric foil, wherein the flexible tool feature is formed on the polymeric foil.

5. The tool of claim 1, further comprising:
a metal foil, wherein the flexible tool feature is formed on the metal foil.

6. The tool of claim 1, wherein the flexible tool feature is a laminate.

7. The tool of claim 1, wherein the flexible tool feature is bonded to the tool face.

8. A molding tool, comprising:
a flexible tool sleeve configured to mold a composite laminate charge into a shaped part; and
at least one polymeric tool feature on the tool sleeve configured to form a shape in the composite laminate charge and maintain a substantially even pressure distribution throughout the part.

9. The molding tool of claim 8, wherein:
the flexible tool sleeve is a metal and includes at least one tool face, and
the polymeric tool feature is bonded to the tool face.

10. The molding tool of claim 8, wherein the polymeric tool feature is a polyimide.

11. The molding tool of claim 8, wherein the flexible tool sleeve and the polymeric tool feature are integrally formed.

12. The molding tool of claim 8, wherein the polymeric tool feature is a flexible polyimide laminate.

13. The molding tool of claim 8, wherein:
the flexible tool sleeve is a polymeric foil, and the polymeric tool feature is a polyimide.

14. A method of forming a composite part, comprising:
positioning a flexible tool feature on a face of a tool;
bringing the face of the tool into contact with a composite charge; and
compressing the composite charge with the tool, including using the flexible tool feature to shape the composite charge.

15. The method of claim 14, wherein positioning the flexible tool feature is performed by bonding the flexible tool feature to the face of the tool.

16. The method of claim 14, further comprising:
machining the flexible tool feature to a desired shape.

17. The method of claim 14, wherein bringing the face of the tool into contact with the composite charge is performed by feeding the tool and the composite charge into a continuous compression molding machine.

18. The method of claim 14, wherein compressing the composite charge with the tool includes forcing the tool toward a matching tool.

19. The method of claim 14, wherein placing the positioning the tool feature on the face of the tool is performed by bonding.

20. A method of compression molding a composite part, comprising:
fabricating a flexible tool sleeve;
positioning at least one flexible tool feature on the flexible tool sleeve;
feeding a composite charge and the flexible tool sleeve substantially continuously through a molding machine; and
compression molding the composite charge into a part, including using the flexible tool feature to shape a feature of the part.
